(19) United States
(12) Patent Application Publication
(10) Pub. No.: US 2013/0197876 A1
(43) Pub. Date: Aug. 1, 2013

(54) KBH Vehicle Weight Efficiency Formula

(71) Applicant: Kenneth Bruce Halstead, East Point, GA (US)

(72) Inventor: Kenneth Bruce Halstead, East Point, GA (US)

(21) Appl. No.: 13/360,755

(22) Filed: Jan. 29, 2012

(51) Int. Cl. G06F 17/10

(52) U.S. Cl. 703/2

(57) ABSTRACT

The simplest possible description of the KBH Vehicle Weight Efficiency Formula might be that of a combination of a weight-per-square-unit parameter with a power-to-weight-ratio parameter. However, the manner in which these two parameters are combined is original logic and the result is an application as a vehicle weight efficiency index value.

### BACKGROUND OF THE INVENTION

The KBH Vehicle Weight Efficiency Formula is a mathematical process or algorithm that has application in vehicle engineering, in vehicle testing, and in vehicle data reporting or data publishing.

### BRIEF SUMMARY OF THE INVENTION

The KBH Vehicle Weight Efficiency Formula allows calculation of a vehicle weight efficiency not dependent on vehicle size. In other words, the KBH Vehicle Weight Efficiency Formula considers vehicle weight, vehicle size, and vehicle power to produce a weight efficiency index value that allows the weight efficiency of a larger vehicle to be compared to the weight efficiency of a smaller vehicle. Or more simply, the weight efficiency of any vehicle can be compared to the weight efficiency of any other vehicle (when of similar wheel layout). Note that vehicle engine power is used as an indicator of vehicle frame strength and is a key component of the calculation of vehicle weight efficiency.

The KBH Vehicle Weight Efficiency Formula has current importance as vehicle manufacturers strive to improve vehicle fuel mileage while attempting to maintain vehicle performance standards. The KBH Vehicle Weight Efficiency Formula also as current importance to consumers who are shopping for vehicles and comparing vehicles. Finally, the KBH Vehicle Weight Efficiency Formula can identify the most weight efficient vehicle construction methods.

### DETAILED DESCRIPTION OF THE INVENTION

The KBH Vehicle Weight Efficiency Formula multiplies a vehicle's average track-width times its wheelbase-length to arrive at a vehicle footprint or vehicle platform square-units. Then the formula divides the vehicle-weight by the vehicle-platform-square-units to arrive at a weight-per-square-unit preliminary index value. Finally, the formula uses the vehicle-engine-power-per-vehicle-weight as a percentage and reduces the preliminary index value by the percentage to arrive at a final index value. The lower the final index value the greater the weight efficiency of the vehicle. Of course, the final index value can be multiplied by a constant and scaled to convenient output.

The process of the KBH Vehicle Weight Efficiency Formula algebraically reduces to a simple form as:

$$Vehicle Weight Efficiency Index Value = \frac{Vehicle Weight - Engine Power}{Vehicle Track \times Vehicle Wheelbase}$$

The validity of the KBH Vehicle Weight Efficiency Formula can be shown with description of a simple example. Vehicle B has the same size and weight as Vehicle A, however Vehicle B has twice the engine power of Vehicle A. Then Vehicle B must have a stronger frame or chassis than Vehicle A and therefor Vehicle B is obviously more weight efficient than Vehicle A. Now apart from the example, a vehicle's power-to-weight ratio is a very good indicator of required frame strength. Also note that Vehicle B, with a stronger frame than Vehicle A, has a larger percentage of its total weight as frame weight. Vehicle B has both a larger percentage of frame weight and a larger percentage of power-to-weight. Overall, frame weight percentage and power-to-weight percentage likely correlate very well since large percentage increases in frame weight would tend to increase total vehicle weight but be relatively small percentage increases in total weight. In other words, noticeable increases in power-to-weight ratio are likely followed by relatively unnoticed increases in frame weight percentage. And therefor, the power-to-weight ratio is the allowance for frame weight within the weight efficiency index value.

Finally, note that engine power could be represented by engine power, by motor power, by engine torque, by motor torque, or by hybrid-system-net-power.

1. The KBH Vehicle Weight Efficiency Formula was developed in the year 2012 by the inventor named in this application who is also known as KBH. The KBH Vehicle Weight Efficiency Application, also by KBH, is a computer program based on the KBH Vehicle Weight Efficiency Formula and available at the website www.kbhscape.com/weight.htm. The KBH Vehicle Weight Efficiency Formula can be licensed for commercial use from KBH with or without the KBH Vehicle Weight Efficiency Application.
